(19) United States
(12) Patent Application Publication
(10) Pub. No.: US 2014/0105729 A1
(43) Pub. Date: Apr. 17, 2014

(54) WIND TURBINE ELECTRICAL GENERATOR

(71) Applicant: Willis Grant Tarbox, Chester, SC (US)

(72) Inventor: Willis Grant Tarbox, Chester, SC (US)

(21) Appl. No.: 14/051,401

(22) Filed: Oct. 10, 2013

Related U.S. Application Data
(60) Provisional application No. 61/714,046, filed on Oct. 15, 2012.

(51) Int. Cl. F03D 9/00

(52) U.S. Cl. CPC F03D 9/00
USPC 415/122.1

(57) ABSTRACT

A wind turbine electrical generator can provide wind powered portable or stationary electrical power at a user site or application without the need of utility services. The wind turbine electrical generator incorporates tunneling and multiplying available wind via funneling to produce more power at a wind turbine driven generator. The generator is portable and is mounted on a utility size trailer frame suitable for permanent anchoring or can moved about as needed. The generator is complete, needing only an electrical connection to the user's intended application.

### CROSS-REFERENCE TO RELATED APPLICATION

This application claims the benefit of priority of U.S. provisional application No. 61/714,046, filed Oct. 15, 2012, the contents of which are herein incorporated by reference.

### BACKGROUND OF THE INVENTION

The present invention relates to wind turbine electrical generators and, more particularly, to a wind turbine electrical generator that is transportable to a user's site, fits within highway size for unrestricted road travel, is packaged complete and ready to generate power by wiring to a user's device, and has anchor points to stabilize and level the generator on site.

Fuel-powered portable generators require engines and fuel, such as gasoline or natural gas, to power them. Water generators require nearby source of flowing water, such as a river or stream. Wind generators for individual use are small and require a high mounting in order to catch strong winds. Due to these design constraints, wind generators for personal use often do not generate a significant amount of power.

As can be seen, there is a need for a portable wind turbine electrical generator that can be easily installed and used on a user's site.

### SUMMARY OF THE INVENTION

In one aspect of the present invention, a wind turbine electrical generator comprises a base section; an upper section pivotably attached to the base section; a center shaft tube formed through the upper section and into the base section, the upper section pivoting on the center shaft tube; a wind tunnel formed in the upper section; a turbine disposed in the wind tunnel; a turbine shaft, turned by wind entering the wind tunnel and impinging upon the turbine; a center shaft tube, disposed inside the center shaft, rotationally connected to the turbine shaft; and at least one generator disposed in the base section and rotationally connected to the center shaft tube.

In another aspect of the present invention, a wind turbine electrical generator comprises a base section; an upper section pivotably attached to the base section; a center shaft tube formed through the upper section and into the base section, the upper section pivoting on the center shaft tube; vanes configured to rotate the upper section to direct an opening of the wind tunnel to face a direction of incoming wind; a wind tunnel formed in the upper section; a turbine disposed in the wind tunnel; a turbine shaft, turned by wind entering the wind tunnel and impinging upon the turbine; a center shaft tube, disposed inside the center shaft, rotationally connected to the turbine shaft; at least one generator disposed in the base section and rotationally connected to the center shaft tube; a front shutdown hood movable over an opening of the wind tunnel to control a flow of wind therethrough; and a trailer frame supporting the wind turbine electrical generator thereupon.

These and other features, aspects and advantages of the present invention will become better understood with reference to the following drawings, description and claims.

### BRIEF DESCRIPTION OF THE DRAWINGS

FIG. 1 is a perspective view of a wind turbine electrical generator according to an exemplary embodiment of the present invention;

FIG. 2 is a cross-sectional view, taken along line 2-2 of FIG. 1, illustrating the movement of wind through the tunnel;

FIG. 3 is a detailed sectional view of a center axle transferring power from the wind turbine to the generator of the wind turbine electrical generator of FIG. 1;

FIG. 4 is a top view of the wind turbine electrical generator of FIG. 1, illustrating rotation of an upper section thereof; and

FIG. 5 is a side view of the wind turbine electrical generator of FIG. 1, illustration movement of a high-wind shutdown device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wind turbine electrical generator that can provide wind powered portable or stationary electrical power at a user site or application without the need of utility services. The wind turbine electrical generator incorporates tunneling and multiplying available wind via funneling to produce more power at a wind turbine driven generator. The generator is portable and is mounted on a utility size trailer frame suitable for permanent anchoring or can moved about as needed. The generator is complete, needing only an electrical connection to the user's intended application.

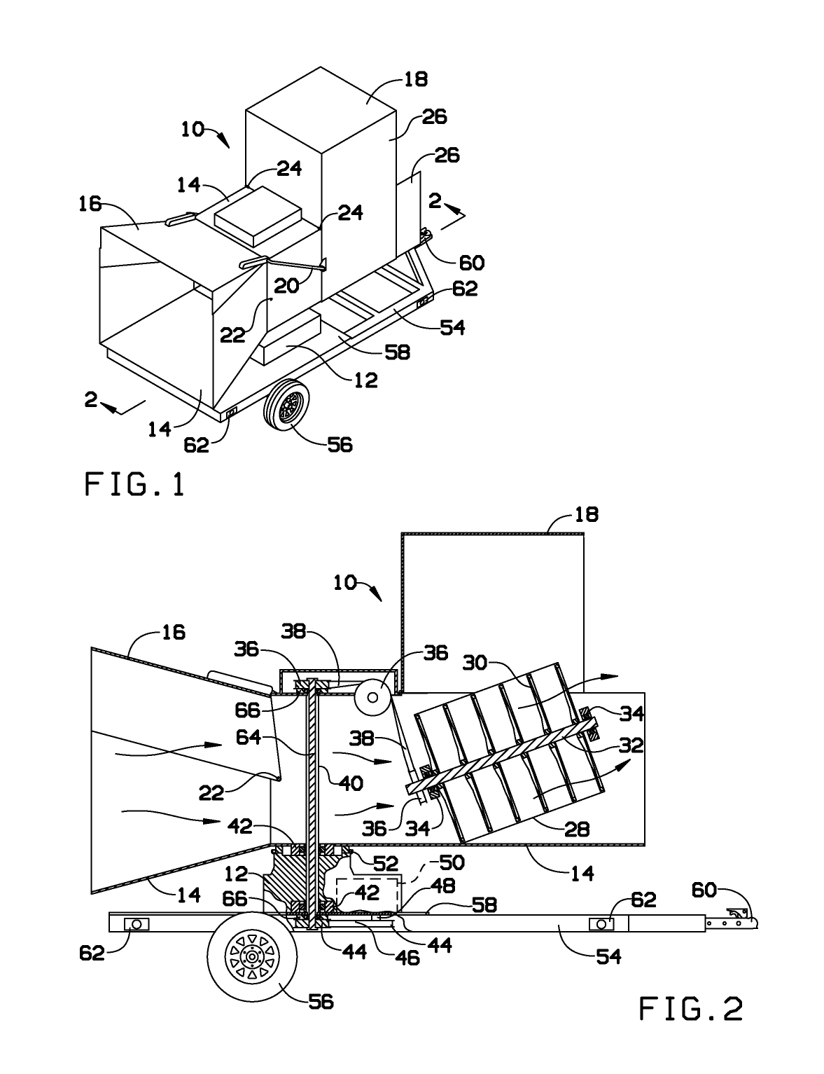

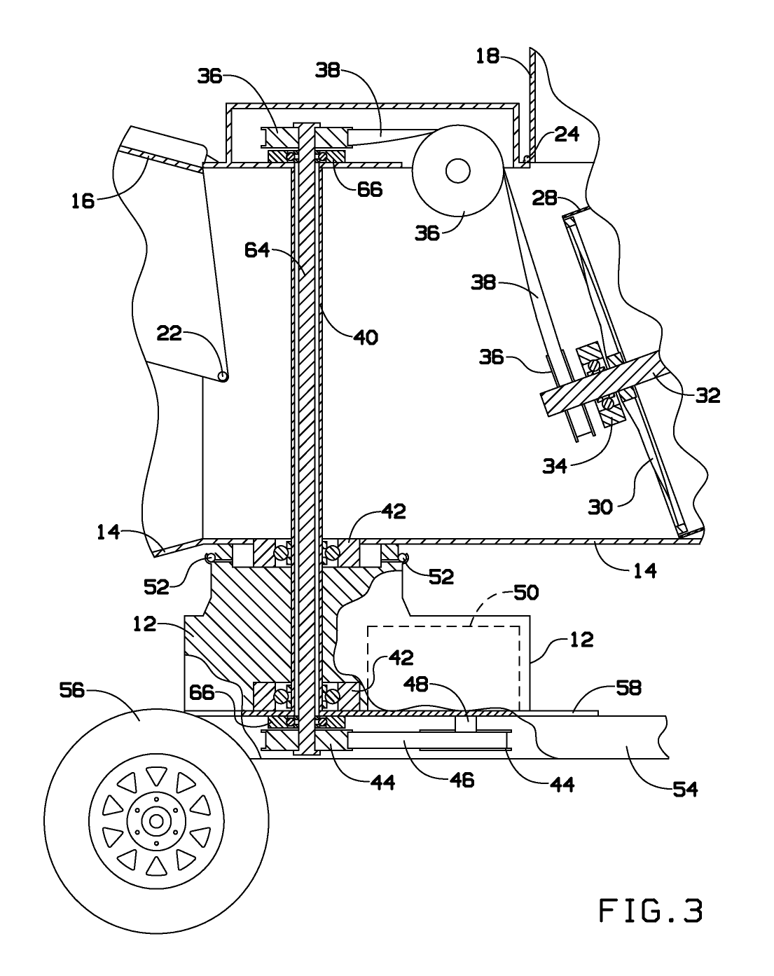

Referring now to FIGS. 1 through 5, a wind turbine electrical generator can include an upper portion 10 mounted on a base section 12. The upper portion 10 can include a wind tunnel 14 that can open to capture incoming wind and direct that wind to a wind turbine 28. The wind tunnel 14 can include a flared opening that can capture and funnel the wind. A front shutdown hood 16 can be closed at least partially over the entrance to the wind tunnel 14, via shutdown hood arms 20, to control wind flow and help prevent the wind turbine 28 from turning too fast. The entrance to the wind tunnel can be hinged so that the flared entrance can be wider than the trailer frame 54. The flared entrance can be folded in along a front hood pivot point 22 and positioned along the sides of the upper section 10 during transport, keeping the generator at an appropriate width for over-the-road travel. Vanes 26 can help keep the wind collector headed into the wind for maximum efficiency.

The wind turbine 28 can include a plurality of turbine wheels 30. The number of turbine wheels 30 can be practically any number, depending on the particular application. For example, FIG. 2 shows six turbine wheels 30, as an example.

As wind enters the tunnel 14 and is compressed and increased in velocity due to the flared shape entrance, the turbine wheels 30 are turned, turning a turbine axle 32. The turbine axle 32 is supported by turbine bearings 34. A turbine pulley 36 can turn with the turbine axle 32. A turbine belt 38 can extend about the pulleys 36 to a pulley 36 on the end of a center shaft 64.

The center shaft 64 can be disposed within a center shaft tube 40. The center shaft tube 40 can have a bearing 42 on each end thereof, allowing the upper section 10 to rotate relative to the base section 12. A center shaft bearing 66 can be disposed on each end of the center shaft 64, supporting the center shaft 64 in the center shaft tube 40.

As the turbine axle 32 moves the turbine belt 38, the center shaft 64 turns within the center shaft tube 40. A pulley 44 at the end of the center shaft 64, within the base section 12, turns a generator belt 46 to drive one or more generator drive axles 48 and, in turn, one or more generators 50.

As mentioned above, the wind turbine electrical generator may be positioned on a trailer that is suitable for transport over the roads. The trailer can include a trailer frame 54 and trailer wheels 56 as may be known in the art. A trailer deck 58 may hold components, such as the generator 50. The trailer can include a hitch receiver 60 for attaching the wind turbine electrical generator and trailer to a vehicle's hitch for portability. A plurality of leveling/tie-down points can be provided, typically at the corners of the trailer, for leveling and/or tying down the trailer. For example, in some embodiments, arm booms can be extended from the sides of the trailer to add stabilization, leveling and support. In some embodiments, the wind turbine electrical generator can include a hydraulic system and/or electrical system for controlling the stabilization devices, as well as for controlling the front shutdown hood 16 and the rear shutdown hood 18.

In some embodiments, the wind turbine electrical generator can be removed from the trailer for mounting to a separate foundation.

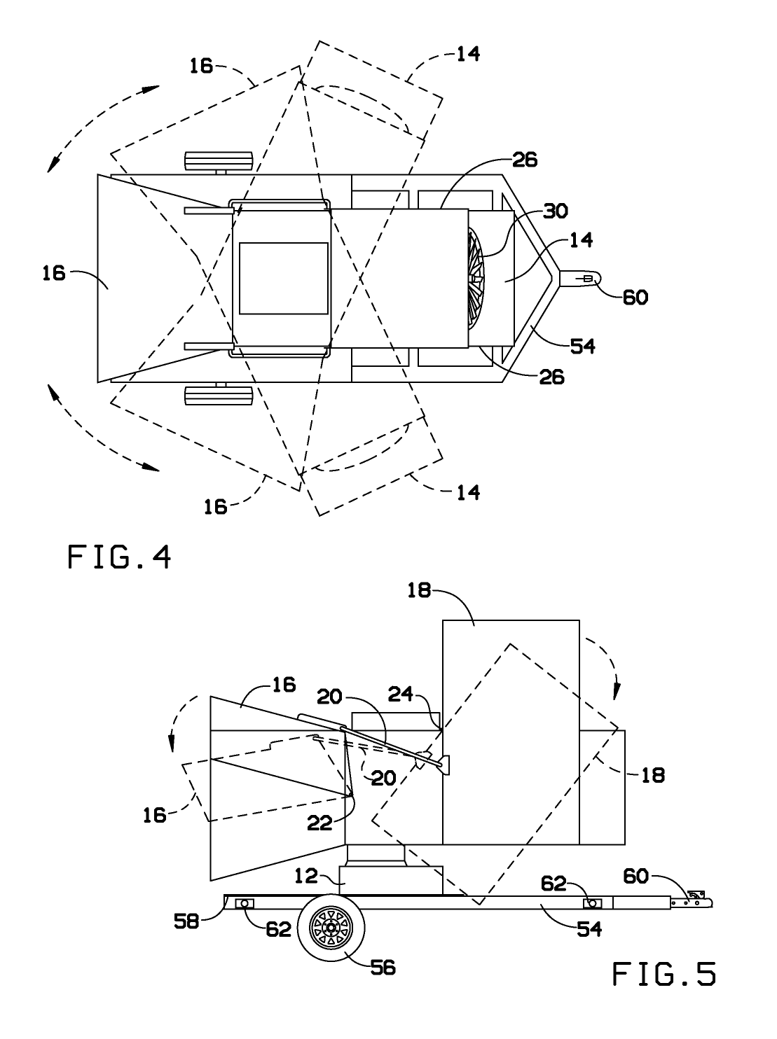

The components of the wind turbine electrical generator work as an integral unit to provide electrical power from the wind with minimal user input. The unit, when set up where wind is available, collects and compresses that wind to its maximum to drive wind turbine driven generators to product electrical power for the user's various applications. When set, anchored and level, the vanes can keep the wind collector (via pivoting as shown in FIG. 4) headed into the wind for maximum efficiency. Power output can be made available in various forms, where it can be stored or used straight from the generators.

The components of the present invention can be constructed from those components known in the art, including sheet metal or fiberglass panels, along with other pre-manufactured components (such as bearings, belts, generators, electrical wiring and the like).

The wind turbine electrical generator can be used in various applications where a remote power source would be advantageous. The wind turbine electrical generator could be used for other uses, such as remote pumping for emergencies or drought, where a pump can be connected in place of the generator.

It should be understood, of course, that the foregoing relates to exemplary embodiments of the invention and that modifications may be made without departing from the spirit and scope of the invention as set forth in the following claims.

What is claimed is:

1. A wind turbine electrical generator comprising:
a base section;
an upper section pivotably attached to the base section;
a center shaft tube formed through the upper section and into the base section, the upper section pivoting on the center shaft tube;
a wind tunnel formed in the upper section;
a turbine disposed in the wind tunnel;
a turbine shaft, turned by wind entering the wind tunnel and impinging upon the turbine;
a center shaft tube, disposed inside the center shaft, rotationally connected to the turbine shaft; and
at least one generator disposed in the base section and rotationally connected to the center shaft tube.

2. The wind turbine electrical generator of claim 1, further comprising vanes configured to rotate the upper section to direct an opening of the wind tunnel to face a direction of incoming wind.

3. The wind turbine electrical generator of claim 1, further comprising a front shutdown hood movable over an opening of the wind tunnel to control a flow of wind therethrough.

4. The wind turbine electrical generator of claim 1, further comprising a belt rotationally connecting the turbine shaft with the center shaft.

5. The wind turbine electrical generator of claim 1, further comprising a trailer frame supporting the wind turbine electrical generator thereupon.

6. The wind turbine electrical generator of claim 5, wherein the trailer frame includes wheels and a hitch receiver.

7. The wind turbine electrical generator of claim 5, wherein the trailer frame includes a plurality of leveling/tie-down points.

8. A wind turbine electrical generator comprising:
a base section;
an upper section pivotably attached to the base section;
a center shaft tube formed through the upper section and into the base section, the upper section pivoting on the center shaft tube;
vanes configured to rotate the upper section to direct an opening of the wind tunnel to face a direction of incoming wind;
a wind tunnel formed in the upper section;
a turbine disposed in the wind tunnel;
a turbine shaft, turned by wind entering the wind tunnel and impinging upon the turbine;
a center shaft tube, disposed inside the center shaft, rotationally connected to the turbine shaft;
at least one generator disposed in the base section and rotationally connected to the center shaft tube;
a front shutdown hood movable over an opening of the wind tunnel to control a flow of wind therethrough; and
a trailer frame supporting the wind turbine electrical generator thereupon.

9. The wind turbine electrical generator of claim 8, wherein the trailer frame includes wheels and a hitch receiver.

10. The wind turbine electrical generator of claim 8, wherein the trailer frame includes a plurality of leveling/tie-down points.
